(19) United States
(12) Patent Application Publication
(10) Pub. No.: US 2003/0203500 A1
(43) Pub. Date: Oct. 30, 2003

(54) High throughput testing of fluid samples using an electric field

(75) Inventors: Eric D. Carlson, Cupertino, CA (US); Oleg Kolosov, San Jose, CA (US)

Correspondence Address: Scott A. Chapple, Dobrusin & Thennisch PC, Suite 311, 401 South Old Woodward Avenue, Birmingham, MI, 48009, US

(73) Assignee: Symyx Technologies, Inc.

(21) Appl. No.: 10/133,938

(22) Filed: Apr. 26, 2002

(51) Int. Cl. G01N 27/416

(52) U.S. Cl. 436/151; 422/82.01

(57) ABSTRACT

A method for high throughput characterization of samples is disclosed. According to the method, a library of samples is exposed to one or more electric fields to determine properties of the samples.

### TECHNICAL FIELD

The present invention generally relates to the field of high throughput materials characterization. In particular, the invention relates to high throughput screens that use an electric field for evaluating fluidic material samples such as emulsions.

### BACKGROUND OF THE INVENTION

Currently, there is substantial research activity directed toward the discovery and optimization of materials such as polymers, oils, surfactants, processing techniques or the like for a wide range of applications, particularly in the area of emulsions. Additionally, substantial research is being directed to formation and processing of such materials. Although the characteristics of these materials including chemistry of the materials, properties exhibited by the materials and the like have been extensively studied, it is often not possible to predict the properties or characteristics that a particular material will exhibit under various conditions or the precise composition and architecture that will result from any particular synthesis scheme. Thus, characterization techniques are an essential part of the discovery process.

Combinatorial chemistry refers generally to methods for synthesizing a collection of chemically diverse materials and/or to methods for rapidly testing or screening this collection of materials for desirable performance characteristics and properties. Combinatorial chemistry approaches have greatly improved the efficiency of discovery of useful materials. For example, material scientists have developed and applied combinatorial chemistry approaches to discover a variety of novel materials, including for example, high temperature superconductors, magnetoresistors, phosphors and catalysts. See, for example, U.S. Pat. No. 5,776,359 (Schultz, et al). In comparison to traditional materials science research, combinatorial materials research can effectively evaluate much larger numbers of diverse compounds in a much shorter period of time. Although such high-throughput synthesis and screening methodologies are conceptually promising, substantial technical challenges exist for application thereof to specific research and commercial goals.

The characterization of materials using combinatorial methods has only recently become known. Examples of such technology are disclosed, for example, in commonly owned U.S. Pat. Nos. 6,182,499 (McFarland, et al); U.S. Pat. No. 6,175,409 B1 (Nielsen, et al); U.S. Pat. No. 6,157,449 (Hajduk); U.S. Pat. No. 6,151,123 (Nielsen); U.S. Pat. No. 6,034,775 (McFarland, et al); U.S. Pat. No. 5,959,297 (Weinberg, et al), all of which are hereby expressly incorporated by reference herein.

Of particular interest to the present invention, which in one preferred embodiment is directed to high throughput analysis of emulsion candidate materials, are combinatorial methods and apparatuses for screening materials for characteristics or properties while the materials are in a fluid state (e.g., as a solid or liquid phase in liquid medium, such as an emulsion, a dispersion or other suspension, a sol-gel or the like). Screening of the materials in this manner presents a multitude of challenges. As an example, characteristics and properties of samples of materials in a fluid state can change over time and the samples can exhibit different properties or characteristics at different locations within the samples. Thus, challenges are presented for technology that can quickly process and test (either in parallel or in serial succession) properties or characteristics of samples while still accounting for such differences and changes in the characteristics and properties of the samples.

### SUMMARY OF THE INVENTION

In one aspect, the present invention is directed to a unique method for screening at least four fluid samples for concentration, comprising the steps of providing an electric field generator connected to a robot arm; providing at least four fluid samples; generating an electric field with the electric field generator; exposing a sample of the at least four samples to the electric field; monitoring a response (e.g., capacitance) of the sample of the at least four samples to the electric field for at least two locations in the sample of the at least four samples; and repeating the generating, exposing and monitoring steps for at least three additional samples. Preferably the method also includes the step of correlating the response monitored with a concentration for each sample in the at least four samples, for example by monitoring it in a single instant, over a period of time, where concentration is determined as a function of time, or over a range of depths where concentration is determined as a function of depth. Optionally, the results may be graphically displayed.

The repeating steps may be performed simultaneously with the initial steps, such as by using a plurality of electric field generators. They may also be performed serially, or with a combination of serial and parallel steps.

One particularly preferred embodiment employs an electrical field generator that includes opposing electrodes spaced about a tube (such as a capillary or other like structure for defining a fluid passageway) through which a sample is passed (e.g., by aspiration using a suitable pressure device, such as a vacuum). An electrical field can be generated by inducing a potential between electrodes. The present invention lends itself well to automation techniques and it is especially contemplated in one embodiment that one or more translatable robot arms are used, such as for translating the sample relative to the generator. Automated sample handling equipment may also be employed. In one embodiment, the tube is disposed of between samples and replaced with another tube, so that the tubes are effectively single-use only tubes. Of course, the tubes can be used for multiple tests with suitable intermediate cleaning steps.

In a highly preferred aspect of the present invention the samples that are screened are plural phase materials, such as emulsions.

The present invention also relates to an apparatus and system for performing analysis in accordance with the preferred methods described herein. One preferred apparatus and system comprises at least one electrical field generator disposed about a sample flow passage and suitable circuitry for measuring the response of a sample to an electrical field induced upon the sample when in the sample flow passage. One particularly preferred apparatus and system is automated and comprises a robot; a tube (e.g., a glass or plastic capillary, suitable for single-use or multiple use application) connected to the robot such that the robot is capable of moving the tube from sample to sample within the library of at least partially fluid sample, the tube having an opening extending through the tube and an outer surface; an electric field generator connected to the tube, the electric field generator including a first conductor attached to the outer surface of the tube and a second conductor attached to the outer surface of the tube, the opening of the tube being at least partially located between the first conductor and second conductor; an energy source electrically connected to the first conductor and the second conductor for inducing an electric field between the first conductor and the second conductor; electrical circuitry electrically connected to the first conductor and the second conductor, the electrical circuitry configured for monitoring a dielectric response of materials that are exposed to the electric field between the first conductor and the second conductor; and a vacuum supply in fluid communication with the opening of the tube for aspirating sample of the library of samples into the opening thereby exposing each sample of the library of samples to the electric field such that the electrical circuitry can monitor the dielectric response of each sample of the library of samples.

### BRIEF DESCRIPTION OF THE DRAWINGS

FIG. 1 shows a flowchart of possible steps for methods of the present invention.

FIG. 2A shows a block diagram of a potential platform system for executing methods and for operating systems of the present invention.

FIG. 2B shows a flowchart of the general steps for the methods of the present invention.

FIG. 3 is a schematic illustration of a portion of an apparatus for characterization of material samples according to one aspect of the present invention.

FIG. 4 is a schematic illustration of the apparatus of FIG. 3.

FIGS. 5(a)-5(c) illustrate graphs used to assist in the determination of concentration of materials within samples of a library.

FIG. 6 illustrates a portion of an electric field generator during determination of concentration of materials within a sample in a library of samples.

FIG. 7 illustrates a portion of an electric field generator during determination of viscosity of a sample in a library of samples.

FIG. 8 illustrates a portion of an electric field generator during determination of a profile of concentration of materials within a sample in a library of samples.

FIG. 9 illustrates a portion of an electric field generator during determination of a profile of concentration of material within a sample in a library of sample.

FIG. 10 illustrates an exemplary graph of the profile of FIG. 8.

FIG. 11 illustrate an exemplary graph of the profile of FIG. 9.

### DETAILED DESCRIPTION OF THE PREFERRED EMBODIMENTS

As will be appreciated from the description herein, the present invention is directed primarily to a screen of a fluid sample. A preferred fluid will be a liquid, though application to gaseous media may also be possible. The fluid may be a single phase, substantially homogeneous material, or it may be a plural phase combination of materials. For example, the fluid samples that may be analyzed in accordance with the present invention may be solutions, emulsions, dispersions, or other suspensions or the like. The sample may also be beads maintained in a fluid medium such as beads that form a synthesis site, which may be analyzed while the beads are in the fluid medium.

These and other aspects of the invention are to be considered exemplary and non-limiting, and are discussed in greater detail below. The several aspects of the characterization instruments and methods disclosed and claimed herein can be advantageously employed separately, or in combination to efficiently characterize a variety of material samples (i.e., samples formed exclusively of a material or samples including the material). Preferably, the material samples are in a fluidic state. In preferred embodiments, these features are employed in combination to form a material sample characterization system that can operate as a high-throughput screen in a combinatorial materials science research program directed to identifying and optimizing novel material samples and processes. Such material samples appropriate for combinatorial research may include, for instance, polymers, catalysts, products of various polymerization reaction conditions, lubricants, oils, surfactants, gels, adhesives, coatings and/or products of new post-synthesis processing conditions. Other materials appropriate for combinatorial research according to the present invention may include, but are not limited to, foodstuffs, cosmetics, beverages, lotions, creams, pharmaceuticals, inks, body fluids, fuels, additives, detergents, surfactants, shampoos, conditioners, dyes, waxes, electrolytes, fuel cell electrolytes, photoresist, semiconductor material, wire coatings, hair styling products and the like.

Combinatorial Approaches for Science Research

In a combinatorial approach for identifying or optimizing materials, properties, conditions or reactions, a large compositional space (e.g., of variable ratios of components within, for example, an emulsion or other composition) or a large reaction condition space (e.g., of temperature, pressure and reaction time) may be rapidly explored by preparing libraries and then rapidly screening such libraries.

For example, combinatorial approaches for screening a library can include an initial, primary screening, in which material samples are rapidly evaluated to provide valuable preliminary data and, optimally, to identify several “hits”—particular candidate samples having characteristics that meet or exceed certain predetermined metrics (e.g., performance characteristics, desirable properties, unexpected and/or unusual properties, etc.).

It may be advantageous to screen more focused libraries (e.g., libraries focused on a smaller range of compositional gradients, or libraries comprising compounds having incrementally smaller structural variations relative to those of the identified hits) and additionally or alternatively, subject the initial hits to variations in process conditions

Once one or more hits have been satisfactorily identified based on the primary screening, libraries focused around the primary-screen hits can be evaluated with a secondary screen--a screen designed to provide (and typically verified, based on known materials, to provide) chemical composition, sample content or process conditions that relate with a greater degree of confidence to commercially-important processes and conditions than those applied in the primary screen. Particular materials, samples, catalysts, reactants, conditions or post-synthesis or processing conditions having characteristics that surpass the predetermined metrics for the secondary screen may then be considered to be “leads.” If desired, identified lead samples may be subsequently prepared in bulk scale or otherwise developed for commercial applications through traditional bench-scale and/or pilot scale experiments.

See, generally, U.S. patent application Ser. No. 09/227,558 entitled “Apparatus and Method of Research for Creating and Testing Novel Catalysts, Reactions and Polymers”, filed Jan. 8, 1999 by Turner, et al., for further discussion of a combinatorial approach to research and particularly polymer science research.

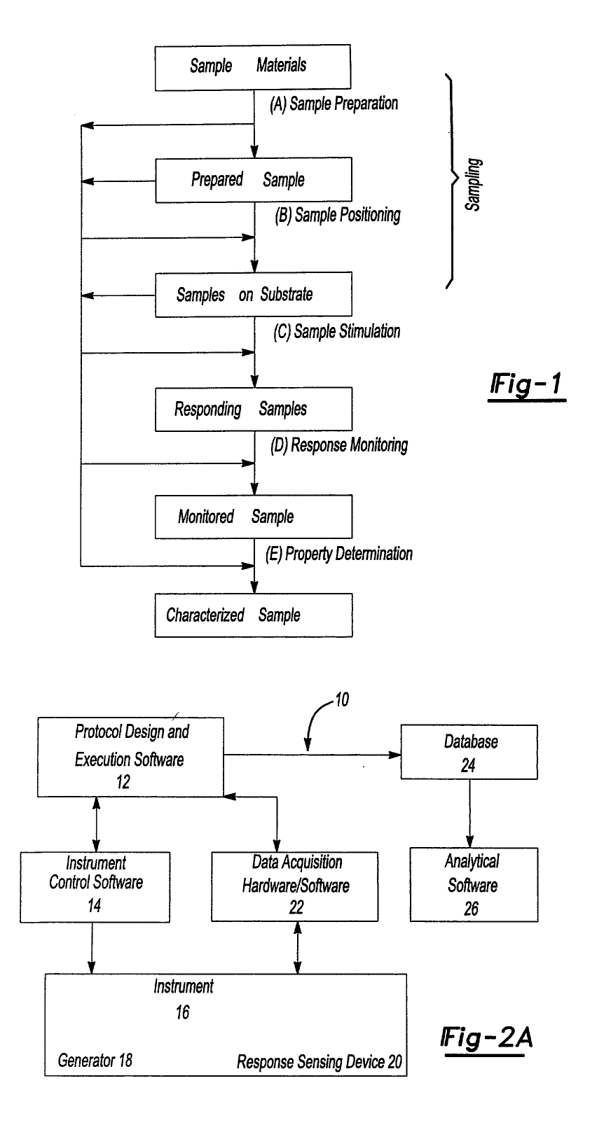

Referring to FIG. 1, the systems and methods, preferably, start with a library or array of material samples that may exhibit one or more predetermined properties or characteristics. Ultimately, these predetermined properties will be determined in a determination step (Step E), however, several prior steps may be affected prior to Step E. The material samples may be prepared such as by heating, cooling, or addition of additives. Such preparation is typically designed to affect the properties that are ultimately being determined. The material samples may also be positioned in a desirable manner for property determination. The sample may be positioned on a substrate, a machine or otherwise positioned to assist in ultimately determining properties of the samples.

It will be appreciated that one of the advantageous features of the present invention is that it affords the ability to screen newly created materials and samples some or all of which are uncharacterized or whose properties are unknown prior to the time of screening. Thus, previously unidentified and uncharacterized new materials and samples can be screened for a common selected property. However, this does not prevent the employment of known references controls or standards as among the library members.

It shall be recognized that sample preparation (Step A) and sample positioning (Step B) may be optional steps in analytical protocols. Also sample preparation and sample positioning may be performed in any order if they are performed. Additionally, it should be recognized that sequences other than the order of steps listed above are possible, and the above listing is not intended as limiting.

Typically, however, stimulation of the material samples (Step C) is needed to affect one or more responses of the materials wherein the responses are related to the one or more characteristics being tested.

The responses of the materials are typically monitored (Step D) with suitable hardware such as sensors, transducers, load cells, electrical circuitry or other like devices. Properties may be determined (Step E) quantitatively or qualitatively by relating the responses to the sample properties.

In general, combinatorial research can be performed in a high throughput manner by art-disclosed rapid-serial, parallel techniques or a combination of these techniques. In a rapid-serial approach, a plurality of samples are consecutively analyzed in relation to each other (i.e., for serial analysis of the samples). In a parallel approach, two or more samples are measured simultaneously. It is also possible that two or more samples can be simultaneously measured advancing to new additional sample on a rapid serial basis. The present invention may be used in connection with any or all of the above high-throughput formats.

Material Samples

The samples for which the present invention is useful for screening may include, amongst other components, polymeric materials, hydrocarbon materials, surfactants or any other fluid, liquid, semi-solid, or solid material that is capable of being provided as part of a fluid, liquid, or other suitable form. Accordingly, without limitation, pure materials, mixtures of materials, bulk materials, dispersions of materials, emulsions of materials, particles of materials and solutions of materials are all contemplated as within the useful scope of the present invention.

In a preferred embodiment, the present invention is employed for screening multi-phase fluid samples. Multi-phase fluid samples may include a solid dispersed in a fluid (e.g., a liquid, gas or combination thereof), a liquid dispersed in a fluid or a gas dispersed in a fluid. For multi-phase samples, one phase may be uniformly or non-uniformly dispersed in another phase. In one highly preferred embodiment, samples according to the present invention may be provided as emulsions that include hydrocarbons (e.g. gas, oil or the like), waxes, gels, polymers or the like, which may form emulsions with water or another liquid. In one preferred embodiment, samples of the present invention are water/oil emulsions (e.g., water in oil or oil in water). In other preferred embodiments, samples may be provided with gasses entrained or dispersed within a fluid (e.g., as foams or the like).

Multi-phase samples may also be provided with dynamically changing compositions. Samples such as emulsions or dispersions may include one phase that is growing, shrinking, increasing in concentration, decreasing in concentration or the like within the emulsion or dispersion. Precipitates, or crystals may be formed or grown within a sample. In one preferred embodiment, one or more polymers may be formed or are forming within a sample.

As examples, samples may be forming emulsion-polymerization products, dispersion-polymerization products or the like. Exemplary methods of forming such samples are disclosed in copending U.S. Provisional Patent Application Serial No. 60/122,704 entitled “Controlled, Stable Free Radical Emulsion and Water-Based Polymerizations”, filed on Mar. 9, 1999 by Klaerner, et al. See also, PCT Patent Application WO 96/11878, each of which is herein incorporated by reference for all purposes. In such cases, for example, the emulsion polymer sample can more generally include one or more polymer components that are insoluble, but (uniformly or non uniformly dispersed), in a continuous phase, with typical emulsions including polymer component particles ranging in diameter from less than about 1 nm to about 500 nm, more typically from about 5 nm to about 300 nm, and even more typically from about 40 nm to about 200 nm. The dispersion polymer sample can, in such cases, generally include polymer component particles that are dispersed (uniformly or nonuniformly) in a continuous phase, with typical particles having a diameter ranging from about 0.2 um to about 1000 um, more typically from about 0.4 um to about 500 um, and even more typically from about 0.5 um to about 200 um.

Samples according to the present invention may include a variety of different additives. Typical additives include a material selected, for example, from one or more of a surfactant, filler, reinforcement, flame retardant, thickner, colorant, environmental protectant, other performance modifier, control agent, plasticizer, cosolvents and/or accelerator, among others. In this regard, the present invention is particularly attractive for the screening of effects of variations of additives upon the characteristics of the material, wherein a library of materials is prepared in which samples vary across the library in respect to an additive employed, a concentration employed, or a combination thereof.

According to another aspect of the present invention, samples may be provided having materials dissolved, dispersed, emulsified or otherwise contained in solvents. Typical solvents include, for example, tetrahydrofuran (THF), toluene, hexane, ethers, trichlorobenzene, dichlorobenzene, dimethylformamide, water, aqueous buffers, alcohols, ketones, etc. According to traditional chemistry conventions, an emulsion can be considered to comprise one or more liquid-phase components emulsified (uniformly or non-uniformly) in a liquid continuous phase, and a dispersion can be considered to comprise solid particles of one or more components dispersed (uniformly or non-uniformly) in a liquid continuous phase.

Sample Size

The sample size is not narrowly critical, and can generally vary, depending on the particular characterization protocols and systems used to analyze the sample or components thereof. However, it will be appreciated that the present invention advantageously permits for attaining reliable data with relatively small samples. Typical sample sizes can range from about 0.1 microgram to about 1 gram, more typically from about 1 microgram to about 100 milligrams, even more typically from about 5 micrograms to about 1000 micrograms, and still more typically from about 20 micrograms to about 50 micrograms.

If and when placed on a substrate for forming a library, as discussed herein with regard to sampling, the samples may be dispensed with any suitable dispensing apparatus (e.g., an automated micropipette or capillary dispenser, optionally with a heated tip). Each sample of the library is preferably dispensed to an individually addressable region such as a well of the substrate. Generally, each sample occupies no more than about 1000 mm² of area on a substrate surface, preferably no more than about 100 mm², more preferably no more than about 50 mm², even more preferably no more than about 10 mm², most preferably no more than about 5 mm², and it is possible for a sample to occupy less than about 1 mm².

In applications where the sample is disposed in a well (e.g. the well of a microtitre plate or a similar structure, preferably the sample size does not exceed about 1000 milligrams. Accordingly, for dispensing high viscosity fluid samples, the individual samples are each dispensed in amounts no greater than about 100 ml, more preferably no greater than about 10 ml and still more preferably no greater than about 1 ml.

Libraries of Sample Materials

Libraries of samples have 2 or more samples that are physically or temporally separated from each other—for example, by residing in different regions of a common substrate, in different substrates, in different sample containers of a common substrate, by having a membrane or other partitioning material positioned between samples, or otherwise. In one preferred embodiment, the plurality of samples preferably has at least 4 samples and more preferably at least 8 samples. Higher numbers of samples can be investigated, according to the methods of the invention, to provide additional insights into larger compositional and/or process space. In some cases, for example, the plurality of samples can be 16 or more samples, preferably 24 or more samples, more preferably 48 or more samples. Such numbers can be loosely associated with standard configurations of other parallel reactor configurations for synthesizing materials for screening herein (e.g., a high throughput sample synthesizer, such as the PPR-48™, a variable from Symyx Technologies, Inc.) or of standard sample containers (e.g., 96-well microtiter plate-type formats). Moreover, even larger numbers of samples can be characterized according to the methods of the present invention for larger scale research endeavors.

In some cases, in which processing of samples using typical 96-well microtiter-plate formatting or scaling is convenient or otherwise desirable, the number of samples can be 96*N, where N is an integer ranging from about 1 to about 100 or greater. For many applications, N can suitably range from 1 to about 20, and in some cases, from 1 to about 5.

Candidate samples (i.e., members) within a library may differ in a definable and typically predefined way, including with regard to chemical structure, processing (e.g., synthesis) history, mixtures of interacting components, post-synthesis treatment, purity, etc. In a particularly preferred embodiment, the samples are spatially separated, such that members of the library of samples are separately addressable for characterization thereof. The two or more different samples can reside in sample containers formed as wells in a surface of the substrate. All samples in a library may be different from each other, however, not all of the samples within a library of samples need to be different samples. When process conditions are to be evaluated, the libraries may contain only one type of sample. The use of reference standards, controls or calibration standards may also be performed, though it is not necessary. Further, a library may be defined to include sub-groups of members of different libraries, or it may include combinations of plural libraries. The samples of a library may be previously characterized, uncharacterized or a combination thereof, so that property information about the samples may not be known before screening.

In general, for analysis of plural samples herein, the sample materials are maintained during analysis on a common supporting structure, such as a suitable substrate. The substrate can be a structure having a rigid or semi-rigid surface on which or into which the library of samples can be formed, mounted, deposited or otherwise positioned. Preferably the substrates will be a structure adapted for receiving at least 4 different samples in spaced relation to each other, such as microtiterplate, a block adapted for holding sample vials or the like. The substrate can be of any suitable material, and preferably includes materials that are inert with respect to the samples of interest, or otherwise will not materially affect the mechanical or physical characteristics of one sample in an array relative to another. Exemplary polymeric materials that can be suitable as a substrate material in particular applications include polyimides such as Kapton™, polypropylene, polytetrafluoroethylene (PTFE) and/or polyether etherketone (PEEK), among others. The substrate material is also preferably selected for suitability in connection with known fabrication techniques. Metal or ceramic are also suitable preferred substrate materials. The substrates may be coated or uncoated or may otherwise comprise a plurality of layers.

Samples are preferably confined during analysis to specific regions of the substrate by placement within suitable sample containers. For example, the sample containers can be formed in or provided to a surface of the substrate as dimples, spots, wells, raised regions, trenches, or the like. Non-conventional substrate-based sample containers, such as relatively flat surfaces having surface-modified regions (e.g., selectively wettable regions) can also be employed. The overall size and/or shape of the substrate or its containers is not limiting to the invention. The size and shape can be chosen, however, to be compatible with commercial availability, existing fabrication techniques, and/or with known or later-developed automation techniques, including automated sampling and automated substrate-handling devices.

The substrate is also preferably sized to be portable by humans, thereby permitting analysis in accordance with the present invention and also permitting for ready handling for performing one or more additional different screens, which is also contemplated herein. In one embodiment, samples are formed directly in containers of the substrate so that no transfer of the samples to the substrate is necessary before analysis. The substrate optionally can be thermally insulated or otherwise thermally controlled, particularly for high-temperature and/or low-temperature applications.

Sample Handling

Handling of sample materials may be accomplished with a plurality of steps, which include withdrawing a sample from a sample container and delivering at least a portion of the withdrawn sample to a substrate. Handling may also include additional steps, particularly and preferably, sample preparation steps. In one approach, only one sample is withdrawn into a suitable liquid or solid dispensing device one sample at a time. In other embodiments, multiple samples may be drawn. In still other embodiments, multiple dispensers may be used in parallel.

In the general case, handling can be affected manually, for example, with a pipette or with a syringe-type manual probe. Preferably, however, the sample(s) are withdrawn from a sample container and delivered to the characterization system in an automated manner—for example, with an automated sample handling device.

In one embodiment, handling may be done using a microprocessor controlling an automated system (e.g., a robot arm). Preferably, the microprocessor is user-programmable to accommodate libraries of samples having varying arrangements of samples (e.g., square arrays with “n-rows” by “n-columns”, rectangular arrays with “n-rows” by “m-columns”, round arrays, triangular arrays with “r-” by “r-” by “r-” equilateral sides, triangular arrays with “r-base” by “s-” by “s-” isosceles sides, etc., where n, m, r, and s are integers).

Overview of Instruments and Methods

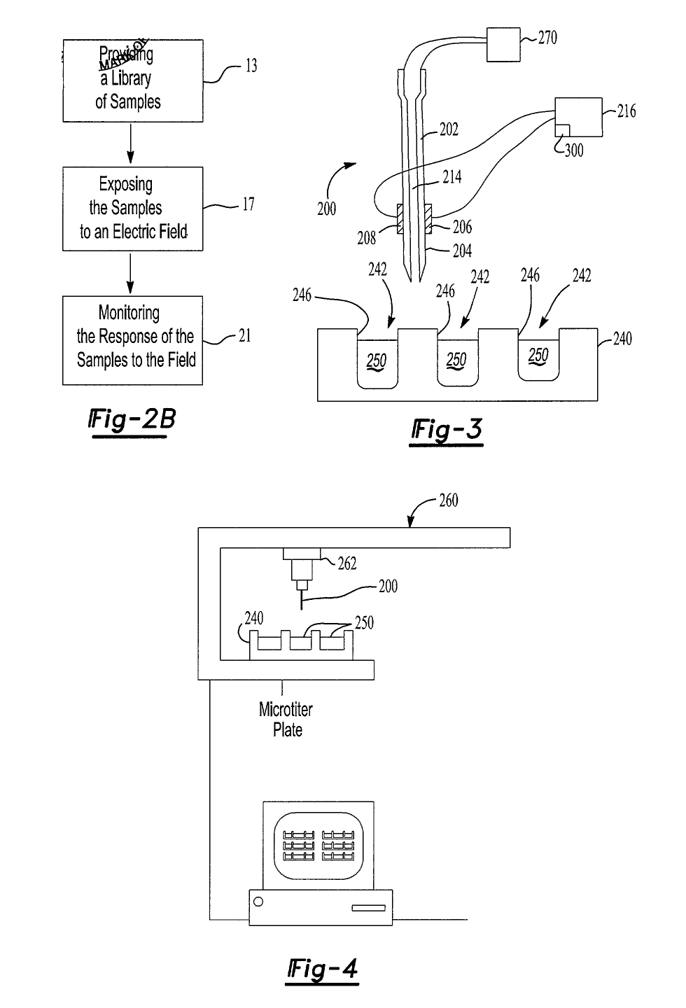

Turning now to the specific system of the present invention, the present invention comprises instruments and methods for screening characteristics and properties of a combinatorial library of materials by using at least one response sensing device to measure the responses of individual library members to electric fields applied by at least one set of conductors. Referring to FIG. 2A-2B, there is a flow schematic diagram of an exemplary automated system 10 for determination of characteristics and properties of a library of material samples and a flowchart 11 of the general steps for the methods of the present invention. Generally, the system 10 includes a suitable protocol design and execution software 12 that can be programmed with information such as synthesis, composition, location information (e.g., with respect to a substrate or substrates) or other information related to a library of samples provided at block 13. The protocol design and execution software 12 is typically in communication with suitable instrument control software 14 for controlling an instrument 16 having at least one electric field generator 18 connected thereto for exposing the samples (either serially or in parallel) to an electric field at block 17. The protocol design and execution software 12 is also in communication with data acquisition hardware/software 22 for collecting data from a response from each of the sample of the library with a sensing device 20. Preferably, the instrument control software 14 commands the generator 18 of the instrument 16 to expose each library member to an electric field in an effort to evoke a response from such library member. At substantially the same time, the response sensing device 20 of the instrument 16 monitors the response of the library member at block 21, the field being applied to the library member or both and provides data on the response to the data acquisition hardware/software 22. Thereafter, the instrument control software 14, the data acquisition hardware/software 22 or both transmit data to the protocol design and execution software 12 such that each library member or information about each library member may be matched with its response to the applied field and transmitted as data to a database 24. Once the data is collected in the database, analytical software 26 may be used to analyze the data, and more specifically, to determine properties and characteristics of each library member, or the data may be analyzed manually.

In a preferred embodiment, the system 10 is driven by suitable software for designing the library, controlling the instruments for mechanical property screening, and data acquisition, viewing and searching, such as LIBRARY STUDIO®, by Symyx Technologies, Inc. (Santa Clara, Calif.); IMPRESSIONIST™, by Symyx Technologies, Inc. (Santa Clara, Calif.); EPOCH™, by Symyx Technologies, Inc. (Santa Clara, Calif.); or a combination thereof. The skilled artisan will appreciate that the above-listed software can be adapted for use in the present invention, taking into account the disclosures set forth in commonly-owned and copending U.S. patent application Ser. No. 09/174,856 filed on Oct. 19, 1998, U.S. patent application Ser. No. 09/305,830 filed on May 5, 1999 and WO 00/67086, U.S. patent application Ser. No. 09/420,334 filed on Oct. 18, 1999, U.S. application Ser. No. 09/550,549 filed on Apr. 14, 2000, each of which is hereby incorporated by reference. Additionally, the system may also use a database system developed by Symyx Technologies, Inc. to store and retrieve data with the overlays such as those disclosed in commonly-owned and copending U.S. patent application Ser. No. 09/755,623 filed on Jan. 5, 2001, which is hereby incorporated by reference for all purposes. The software preferably provides graphical user interfaces to permit users to design libraries of materials by permitting the input of data concerning the precise location on a substrate of a material (i.e., the address of the material). Upon entry, the software will execute commands to control movement of the robot, for controlling activity at such individual address. The versatile instruments and methods of the present invention can screen libraries of material samples based on many different properties such as capacitance, permittivity, dielectric constant, viscosity or the like.

Electric Field Generator

An electric field generator according to the present invention is meant to include any mechanism, instrument or otherwise, which can generate an electric field between at least a first and a second location such as between two or more electrodes. Accordingly, various electric field generators may be used in the present invention. Generally speaking, an electric field generator preferably will include at least one conductor for forming an electric field about the conductor and more preferably will include one or more sets of conductors (e.g., 2, 3, 4 or more conductors) for forming an electric field therebetween.

As used herein, the term “conductor” is intended to mean a material capable of maintaining or transmitting an electrical charge or current. Thus, as used herein, the term “conductor” is intended to mean more than a material that is configured for transferring an electrical current from one location to another. Rather, the term conductor is intended to mean any material capable of transferring electrical current whether it is configured to do so or not.

In a preferred embodiment, each electric field generator of the present invention is formed of a plurality of conductors, which includes at least a first conductor and a second conductor. Such sets of conductors may be provided in a variety of configurations and shapes and may be formed of a variety of materials. As examples, the conductors may be provided as rods, plates, discs, wires, coils, or the like, preferably opposing each other, e.g., as elongated members spaced apart from each other or otherwise. They may be interleaved, or possibly even woven. The conductors may be formed of various conductive materials such as metals, (e.g., copper, gold, silver) conductive plastics or other suitable materials. The conductors may be supported by one or more holders or support members or the conductors may support themselves. Preferably, an opening is located between the first and second conductors of each set of conductors such that fluid samples may pass through the opening.

In one embodiment, an electric field generator is provided as a first conductor and a second conductor, which are both supported by individual separate members or by a common member. The conductors are spaced for defining an opening, for allowing the passage of material samples therethrough. In this manner, it is possible to place suitable tube (such as a capillary or other like structure for providing a fluid passageway). The conductors may be permanently attached to the tube or removeably attached. Thus, the tube may be adjustably translatable independent of the position of the conductors or it may be secured for simultaneous translation with the conductors.

Referring to FIG. 3, there is illustrated an electric field generator 200 according to a preferred aspect of the present invention. In the embodiment shown, the generator 200 is comprised of a capillary tube 202 with an outer surface 204 having a first conductor 206 and a second conductor 208 attached to the outer surface 204. An opening 214 extends centrally down the capillary tube 202 and is located at least partially between the first and second conductors 206, 208. As shown, each of the conductors 206, 208 is electrically connected (e.g., via wires, busses or otherwise) to an electric energy source 216 (e.g., an inductor, a transformer, a potentiostat, battery or other suitable power source) for inducing an electric potential between the conductors 206, 208 thereby forming an electric field between the conductors 206, 208. Optionally the conductors can be placed with the capillary, or even as a sheath or other structure that is eternal of the capillary and at least partially surrounds the capillary. Further other channel-containing structures may be substituted for the capillary, such as those having a diameter that varies along the length of the channel.

It is also possible to employ more than one electric field generator 200 or more than one automated system 262 (e.g., plural robot arms) simultaneously. For instance, 2, 3, 4, 5, 6, 12, 24, 48 or more electric field generators may be attached to and/or supported by a single dynamic automated system or a substantially stationary frame wherein the electric field generators may operate serially, in parallel or a combination thereof. Alternatively, each of 2, 3, 4, 5, 6, 12, 24, 48 or more automated systems 262 may be attached to and/or may support 1, 2, 3, 4, 5, 6, 12, 24, 48 or more electric field generators 200 wherein the automated systems 262 may operate serially, in parallel or a combination thereof.

It is contemplated in one embodiment that the generators are adapted for translation between, among or within samples by any suitable manual or automated manner. In this regard preferably the generators are mounted directly to a robot arm or to a robot arm via an intermediate carrier or holder. The manner of securing the generators to the robot arm is not critical and in one embodiment the generator is equipped with a suitable fitting that enables it to be connected rapidly to the robot arm, or even interchanged with other test device probes, sensors, or other workpieces that are adapted for use with the same robot arm.

In order to avoid contamination, it is preferred that after the screening or measurement of a fluid sample 250 has been taken, the capillary 202 and the opening 214 are cleaned (e.g., flushing with solvent) before screening of another fluid sample is performed. Any cleaning agent (e.g., solvent) that is used should be compatible with the fluid sample 250 and all surfaces it will come into contact with including, without limitation, the materials used for the capillary 202. This cleaning process can be done manually, or automatically, such as by using art-disclosed methods and devices, such as by programming a robot arm and syringe pump of a type like that available from Tecan Systems (formerly Cavro Scientific Instruments)(San Jose, Calif.); see also, U.S. Pat. Nos. 5,476,358, 5,324,163, and WO99/51980, which are all incorporated herein by reference.

Alternatively, for rendering them suitable for single-use application, the capillary 202 can be constructed of disposable materials (e.g., polyethylene, polypropylene, nylon, glass, fluoropolymers, urethanes, or the like), affording disposability; for example, disposable plastic syringes with a suitable glass, plastic or metal capillary may be used. In this case a suitable automated mechanism preferably is provided to load a capillary, reservoir, or both prior to a test of a particular sample, and to discard them after the test is completed.

Material Samples

Material samples may be provided in a variety of ways, some of which have been previously described. In preferred embodiments of the invention, a library of at least partially fluidic material samples is provided in a plurality of wells defined by a plurality of vessels. In one highly preferred embodiment, each of the samples is a multi-phase sample such as an emulsion, a dispersion or the like. As examples, samples may include a polymer growing within a solution or an oil in water (e.g. an emulsion) sample. In alternative embodiments, each of the samples may be a substantially homogeneous sample such as a sample that includes a polymer or other material dissolved in a solvent or a sample containing a catalyst, surfactant or other agent within a solution.

In FIGS. 3 and 4, a substrate 240 is provided having a plurality of wells 242 defined by vessels 246. The vessels 246 may be integral with the substrate 240, for example, wherein the substrate 240 is a microtiter plate. Alternatively, the vessels 246 may be removable from the substrate 240, such as vials in a vial rack. As shown, a plurality of material samples 250 is supported by the vessels 246 within the plurality of wells 242.

It will be appreciated that the placement of material samples 250 into the vessels may be performed manually or in an automated manner, such as by use of an automated liquid dispenser. In this regard, one embodiment of the present invention contemplates employing a work station that includes an automated sample handling device such as an automated fluid dispenser and a robot arm with the generator thereon. The sample handler and the robot arm, for example may be spaced apart from each other and be connected to a common frame and work surface. The work surface optionally may include heaters, mixers or the like for processing the samples.

As mentioned, the present invention preferably includes employing a manual or automated mechanism for exposing the library of samples either serially, in parallel or a combination thereof to one or more electric fields from the generator.

In one preferred embodiment, samples are exposed to an electric field by positioning the samples individually or as a group between at least two conductors of the electric field generator. One particularly preferred embodiment of the present invention contemplates analysis of a sample at different locations within the sample, such as at different heights within the sample. Use of a robot arm controllable in the vertical or z-axis helps provide precise operation of generator height for this embodiment. Another preferred embodiment contemplates the measurement of a fixed position generator over time (either continuously or at periodic intervals). Combinations of these modes may also be employed. Alternatively, a single application of an electric field that is constant, or variable is also possible. To expose each of the samples of the library to the electric field, various techniques may be used depending upon the configuration of the conductors and other factors. In one embodiment, one or more sets of conductors may be moved simultaneously or serially relative to the samples for exposing the samples to the electric fields of the conductors. As an example of one such embodiment, one or more sets of conductors may be attached to one or more automated mechanisms such as robot arms or other machines for moving the conductors from sample to sample to expose successive samples to the electric field and for moving the conductors within the samples to expose various different portions of the sample to the electric field.

In an alternative embodiment, the material samples may be moved relative to one or more sets of conductors for exposing the samples to the electric field of the conductors. As an example of such an embodiment, one or more members may support a set of conductors wherein each of the members defines an opening between the conductors and each opening is in communication with a vacuum supply for urging the samples through the opening. In such an embodiment, several conductor/member combinations may be attached to a frame for simultaneous exposure of samples to the electric fields of the sets of conductors.

In still other alternative embodiments, the material samples and the conductors may both be moved relative to each other for exposing the samples to the electric field. Referring to FIGS. 3 and 4, there is illustrated an apparatus 260 comprised of the electric field generator 200 connected to an automated system 262 (e.g., a robot arm having mobility in at least the x, y and z axes) for moving the generator 200 from sample 250 to sample 250 within the library of samples 250.

In operation, the automated system 262 moves the generator 200 to a first sample 250 and at least partially submerges a tip of the capillary tube 202 (or other suitable structure) within the first sample 250. Once submerged, a vacuum supply 270 lowers the pressure within the opening 214 of the tube 202 for aspirating portions of the first sample 250 within the opening 214 of the tube 202 and through its passageway. The vacuum supply 270 may be provided as a syringe, a shunted line or the like. It is also possible to introduce samples into the capillary tube or other structure by applying a positive pressure upon the fluid, or no pressure at all (e.g. by capillary action).

The tip of the capillary tube 202 that is submerged in the samples 250 may be configured in a variety of manners. For example, the tip may be enlarged, constricted or equivalently sized relative to the passageway defined within the tube 202. The tip may be flat, rounded, chamfered or otherwise configured. In preferred embodiments, the tip of the tube 202 and the portion of the opening 214 at the tip are sized such that, for samples 250 including plural phases, each phase will be aspirated into the tube 202 in general correspondence with its local composition or concentration within the sample 250. It will thus be appreciated that concentration or compositional gradients present within the receptacle holding the sample can be reproduced within aspirated sample itself. Thus, one embodiment of the present invention contemplates aspirating into the tube a sample that reproduces gradients present in the sample receptacle.

Before, during or after the start of aspiration into the tube 202, the energy source 216 is employed for inducing an electric potential between the first conductor 208 and the second conductor 206 for forming an electric field therebetween. For example, in one embodiment, as the first sample 250 is aspirated further into the opening 214 of the tube 202, the sample 250 becomes positioned adjacent or, more preferably, directly between the first conductor 208 and the second conductor 206 thereby exposing the sample 250 to the electric field for a time and in an amount sufficient for an electrical response of the sample to the electric field to be monitored (e.g., measured quantitatively, indexed, compared with a threshold or the like).

Thereafter, the first sample 250 can purged from the tube 202 (e.g., by providing overpressure within the opening 214 of the tube 202) back into its original vessel 246 or elsewhere. If not performed in parallel with the simultaneous testing of other samples, the automated system 262 preferably is adapted for physically translating the electric field generator 200 to locations of additional samples 250, and the process described above will be repeated consecutively for the additional samples.

From the above, it will be appreciated that in one embodiment (as shown) the conductors are spaced from the tip of the tube. In this manner, the conductors need not be submerged in a sample. In another embodiment, the conductors are juxtaposed with the tip, or even placed before the tip opening, and may be submerged. Thus, it is also possible that some or all of the conductors herein may be coated or encapsulated over some or all of its exposed surfaces.

As gleaned from the above, for the electrical response of a sample to an electric field to be monitored, there is employed one or more suitable devices such as transducers, sensors, suitable electronics or the like. Preferably such monitoring device is in signaling communication with a suitable host computer, such as one adapted for relating the monitored responses of the samples to properties of the samples, for providing a graphical display output, for storing monitored information about the samples, for correlating the monitored information with known information about the sample, for controlling a component of the system (e.g., as a threshold trigger) of the invention or otherwise.

For instance, various electrical field responses of the material samples may be monitored to determine properties or characteristics of the samples. It is contemplated that monitoring the responses of the sample may directly provide the properties or characteristics of the samples or that the properties or characteristics may be determined by mathematical equation or otherwise derived from the responses of the samples.

According to one embodiment, the responses of the samples to the electric field are electrical responses of the samples. Exemplary electrical responses, which may be monitored, include excitation of the samples at various electrical frequencies, the ability of the samples to maintain an electrical charge, the separation of charges within a sample or the like. From such responses, various electrical properties or characteristics such as capacitance, conductance, electron density, valence charge density, polarization, permittivity, dielectric response or the like of the samples may be determined. Such electrical properties or characteristics are typically determined directly from the electrical responses of the samples although that need not necessarily the case.

In alternative embodiments, it is contemplated that electrical responses of the samples to the electrical field may be used for determining non-electrical properties or characteristics of the samples. As an example, electrical responses of the samples may be used to monitor motion or movement of a sample in response to one or more forces or pressures applied to the sample and such motion or movement of samples may then be related to rheological or other properties such as viscosity of the samples.

By way of one example, without limitation, the apparatus 260 of FIGS. 3 and 4 can be used to determine concentrations of various components within each sample 250 of the library of samples 250. For determining such concentrations, the conductors 206, 208 are electrically connected to a response sensing device 300. The response sensing device 300 preferably includes electrical circuitry configured for monitoring dielectric responses or excitation frequencies of the samples 250 in response to exposure to the electric field between the conductors 206, 208. As shown in FIGS. 3 and 4, the sensing device 300 is integrated into the energy source 216, however, it shall be understood that the device 300 may be integrated into other portions of the apparatus 260 or may be provided as a separate unit. Additionally, it is contemplated that the response sensing device may include a plurality of units (e.g., electrical circuitry units) connected to a plurality of electric field generators for monitoring samples simultaneously.

An example of a response sensing device 300 is a network analyzer that is adapted for data acquisition. The network analyzer preferably includes a source (e.g., for providing a signal), a test set for separating the signal produced by the source into an incident signal, sent to the sample being analyzed, and a reference signal against which the transmitted and reflected signals are subsequently compared, and a suitable microprocessor (with an optional display), for receiving and processing the signals, such as by making amplitude or phase measurements of the transmitted or reflected signals, such as may be occasioned by the response of the sample to the applied electrical field. An example of one preferred network analyzer is the HP NETWORK ANALYZER Model No. HP4395A, commercially available from the Hewlett-Packard Corporation.

It is possible to employ the present invention to acquire qualitative data or even relative performance data. In such instances, it is optional to employ any calibration steps or to take into account background dielectric response. In one preferred embodiment, however, such as to determine concentrations of components within the samples 250, a background dielectric response (e.g., excitation frequency) is determined for a background fluid by exposing the background fluid to the electric field of the conductors 206, 208 and monitoring the dielectric response of the background fluid. The background fluid is typically the fluid (e.g., air) of the environment surrounding the apparatus 260.

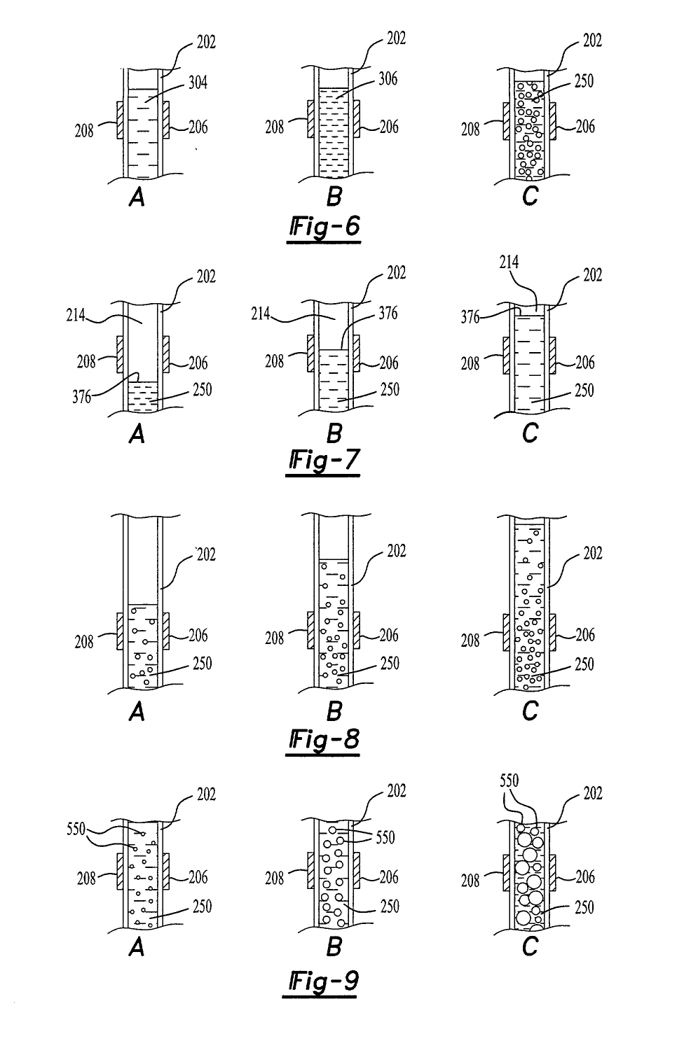

With additional reference to FIG. 6, dielectric responses are also determined for a series of fluids, which are preferably neat or pure samples of the fluids or components that will be within the library of samples 250. For example, and without limitation, the samples 250 of the library may be composed of 2 or more fluids such as oil and water. Thus, a dielectric response may be determined for a sample 304 of pure water and a sample 306 of pure oil by aspirating each of these samples into the tube 202 and monitoring the dielectric response of the neat samples 304, 306 to the electric field of the conductors 206, 208. Additionally, dielectric responses are also determined for each of the samples 250 of the library by aspirating each of the samples 250 into the tube 202 and monitoring the dielectric responses of the samples 250 to the electric field of the conductors 206, 208 with the sensing device 300.

For determining the concentrations of the different components within the library of samples 250, various techniques may be used. According to one embodiment, the dielectric response of the background fluid is subtracted from the dielectric responses of the neat samples and from the dielectric responses of the samples 250 of the library to acquire differences between these dielectric responses. Thereafter, the dielectric responses of the samples 250 of the library are normalized relative to the dielectric responses of the neat samples 304, 306 to determine the percentages of the different fluids in the samples 250.

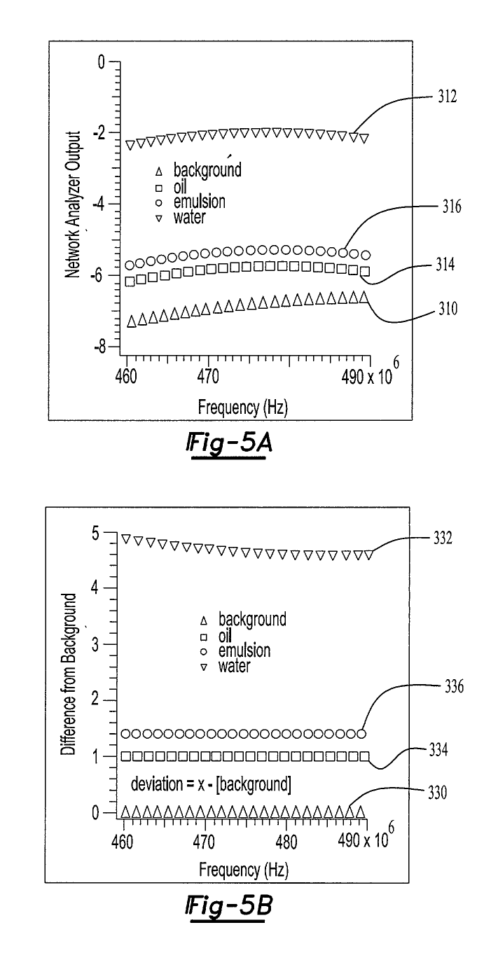

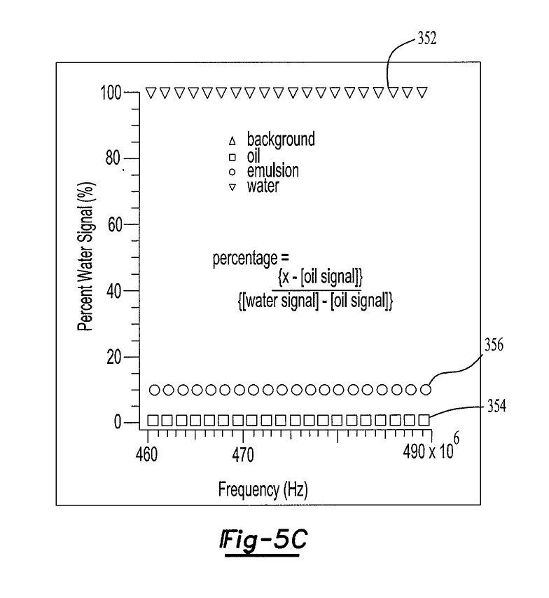

As an example, and without limitation, FIGS. 5(a)-5(b) illustrate determination of the concentrations of oil (e.g., diesel fuel) and water in one oil in water emulsion sample 250 of a library of samples. Referring to FIG. 5(a), there is illustrated a graph of a dielectric response 310 of air, a dielectric response 312 of a neat water sample, a dielectric response 314 of a neat oil sample and a dielectric response 316 of a sample 250 of an oil/water emulsion. As shown, the dielectric responses 310-316 are taken at excitation frequencies between about 460 and 490 MHz. The dielectric response 310 of air is about −7 dB, the dielectric response 312 of the neat water sample is about −2.1 dB, the dielectric response 314 of the neat oil sample is about −5.9 dB, and the dielectric response 316 of the sample of oil/water emulsion is about −5.75 dB. In FIG. 5(b), there is illustrated a graph that illustrates differences 330, 332, 334, 336 taken by subtracting the response 310 of the background fluid respectively from the responses 310, 312, 314, 316 of the background fluid, the neat water sample, the neat oil sample and the oil/water emulsion sample. Then, in FIG. 5(c), there is illustrated a graph of percentages 352, 354, 356 of water resulting respectively from normalizing the differences 332, 334, 336 shown in FIG. 5(b) according to the following equation:

$$Percentage of Water = \frac{100 * [ ( sample response ) - ( oil response ) ]}{[ ( water signal ) - ( oil signal ) \}}$$

As shown in FIG. 4(c), the percentage 352 of water in the neat water sample is about 100%, the percentage 354 of water in the neat oil sample is about 0% and the percentage 356 of water in the oil/water emulsion sample is about 10%. Accordingly, it should be recognized that the apparatus 260 of FIGS. 3 and 4 can be used to determine concentrations of an entire library of samples 250 relatively quickly.

By way of another example, the apparatus 260 of FIGS. 3 and 4 can be used to monitor movement of a sample to determine viscosity of the samples 250 of the library. In such an embodiment, the vacuum supply 270 of the apparatus 260 preferably applies a constant pressure to aspirate a sample 250 into the tube 202. As the sample 250 is aspirated into the tube 202, the response sensing device 300 monitors the rate at which the sample 250 moves through the tube 202. Then, by relating known values such as the constant pressure from the vacuum supply 270, the dimensions of the opening 214 of the tube 202 and the rate of aspiration into the tube 202 to the unknown viscosity of the sample 250, the viscosity of the sample 250 may be solved for. Exemplary equations for determination of viscosity of samples flowing through a capillary tube are disclosed in commonly owned copending U.S. patent application Ser. No. 09/578,997, titled “High Throughput Viscometer and Method of Using the Same”, filed May 25, 2000, herein incorporated by reference for all purposes. See also, copending provisional patent application, attorney docket number 1012-161P1, titled “High Throughput Capillary Viscometer System and Method”, filed Apr. 10, 2002, herein incorporated by reference for all purposes.

Referring to the exemplary embodiment of FIG. 7, there is illustrated one preferred protocol for using the response sensing device 300 to monitor the movement of samples 250 of a library between the conductors 206, 208 as the samples are aspirated into the tube 202 such that viscosity of the samples 250 may be determined. During aspiration of a sample 250, but before the sample 250 is exposed to the electric field between the conductors 206, 208, as shown at A in FIG. 7, the response sensing device 300 is sensing a dielectric response of whatever background fluid 370 (e.g., air) is between the conductors 206, 208. The dielectric response of the background fluid 370 will typically remain substantially constant. Then, as the sample 250 is aspirated to fill the portion of the opening 214 between the conductors 206, 208, as shown at B in FIG. 7, the response sensing device 300 senses a composite dielectric response of the background fluid 370 and the sample 250 as an interface 376 of the fluid 370 and sample 250 travels past the conductors 206, 208. The composite dielectric response will continuously and preferably linearly change as the interface 376 travels past the conductors 206, 208. Aspiration of the sample then continues until only the sample 250 is between the conductors 206, 208 such that the response sensing device 300 is sensing only the dielectric response of the sample 250. At this point, the dielectric response will become substantially constant if the sample 250 is substantially homogeneous. Thus, the amount of time that the dielectric response is a composite response (e.g., a changing response) is equivalent to the amount of time for the sample 250 to travel past the conductors 206, 208. This amount of time may be monitored and is indicative of the rate of travel of the sample 250 through the tube 202, which as discussed above, may be related to the viscosity of the sample 250.

As another example, without limitation, it is contemplated that the present invention may be use to measure affinity of one sample of library for another sample or material. For example, and without limitation, one or more conductors may be used to determine a first dielectric response for a material (e.g., a solid material, air or the like). Then, the one or more conductors or the material be exposed to a sample of a library thereby allowing at least a portion of the sample to attach itself to the material or the conductor followed by determining a second dielectric response for the material or the conductor. The second dielectric response may then be compared to the first dielectric response to determine any change in dielectric response and the change in response may then be correlated to the affinity of the sample for the material or for the conductors. Exemplary affinities, which may be measured, include hydroscopicity, DNA affinity or the like.

In certain situations, it may be desirable to develop profiles of characteristics or properties of samples within a library. As used herein the phrase “profile of a characteristic or property of a sample” is intended to encompass values related to a characteristic or property of a sample that are determined or measured with respect to any second variable. Thus, a profile of a property or characteristic of a sample might include the determination of values of properties such as concentration, viscosity or the like of the sample with respect to a second variable such as time, location within a sample, pressure or force applied to the sample or the like.

Typically, the values or changes in the values related to the characteristic or property will be determined as the second variable changes. For example, and without limitation, a profile of concentration of an emulsion sample may be determined with respect to location (e.g., depth within the sample) by varying the location within the sample at which the concentration is determined. As another example, a profile of growth of a material within a sample may be determined with respect to time by continuously or intermittently determining the amount of the material present within the sample over a period of time.

By way of example, the apparatus 260 of FIGS. 3 and 4 may be used to determine concentration profiles for emulsion samples 250 of a library. In FIG. 8, there is illustrated an exemplary emulsion sample 250 of oil and water as the sample 250 is progressively aspirated into the tube 202 from A to B to C. As shown, the relative concentrations of the components (i.e., oil and water) are changing as the sample 250 is aspirated into the tube 202. During aspiration of the sample 250 concentrations of the components within the sample 250 may be continuously or intermittently determined as previously discussed in relation to FIGS. 5(a), 5(b), 5(c) and 6 to create a profile of the concentration of the sample 250.

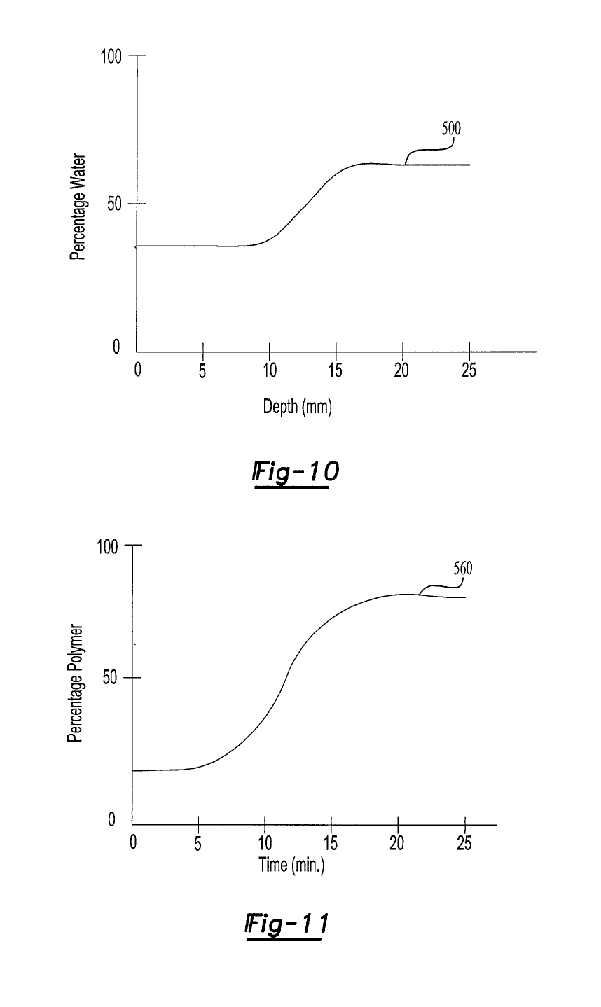

The profile of the concentration of the sample may be determined with respect to a variety of variables such as time, location within the sample or the like. In a preferred embodiment, and with additional reference to FIG. 10, an exemplary profile 500 of concentration of the sample 250 is illustrated with respect to depth of the capillary tube 202 within the sample 250. In this preferred embodiment, the capillary tube 202 is moved at a substantially constant rate through the depth of the sample 250 and the profile 500 of concentration (e.g., percentage water) of the sample 250 is determined with respect to the depth at which various portions of the sample 250 are aspirated into the capillary tube 202.

As another example, the apparatuses and methods of the present invention may be used to determine a profile of growth of a material within a sample. In FIG. 9, there is illustrated an exemplary sample 250, which includes polymer beads 550 progressively growing within a solution in the capillary tube 202. As shown, the relative concentrations of the components (i.e., polymer and solution) are changing with respect to time from A to B to C. Accordingly, concentrations of the components within the sample 250 may be continuously or intermittently determined over time as previously discussed in relation to FIGS. 5(a), 5(b), 5(c) and 6 to create a profile of the concentration of the sample 250.

In a preferred embodiment, and with additional reference to FIG. 11, an exemplary profile 560 of concentrations of the sample 250 is illustrated with respect to time during which the polymer beads 550 are growing within the sample 250 in the tube 202. In this preferred embodiment, the profile 560 of concentration (e.g., percentage polymer beads) of the sample 250 is determined with respect to the time at which concentrations are taken.

It is contemplated that profiles of various different properties or characteristics of samples may be developed using the methodologies and apparatuses disclosed herein. As an example, it is contemplated that a viscosity profile may be determined according to the present invention by relating the rate of change of the rate of aspiration of a sample 250 into the tube 202 to the viscosity of the sample 250. It is also contemplated that profiles of properties or characteristics such as capacitance, conductance, electron density, valence charge density, polarization, permittivity, dielectric response, particle size of fluid or dispersed particles, affinity of one material for another, concentration of a second, third or fourth component (e.g., from a homogenous solution or heterogenous dispersion), composition or the like of the samples may be determined. Moreover, all the characteristic or properties may be determine with respect to a variety of variables such as position, pressure, shear, shear rate, depth, time, temperature, electric field, magnetic field, pH, light intensity, a combination thereof or the like.

It should be understood that, although the response monitoring and property determination has typically been discussed in relation to samples 250 that are being aspirated into the tube 202, it is contemplated that such responses and properties may be monitored and determined as a sample 250 flows out of the tube 202 after the sample 250 has been aspirated. It is further contemplated that one or more conductors or sets of conductors could be attached to a single container or several containers (e.g., vials) for monitoring concentration or concentration changes (e.g. polymer bead growth) within one or more samples in the containers. As an example, a rack of vials may be provided wherein each of the vials supports a different sample of a library and wherein each of the vials is associated with one or more conductors for determining dielectric responses of the samples (e.g, with respect to time). Alternatively, one container may support a sample and the container may be associated with multiple conductors or sets of conductors for determining dielectric responses at various different locations within the sample.

Since the properties of materials can depend on environmental conditions—temperature, pressure, ambient gas composition (including humidity), electric and magnetic field strength, and so on—the screening instruments discussed above may include a control system for regulating environmental condition. Useful control systems may include an environmental chamber that encloses the samples, the sample holder, the apparatus or a combination thereof. The system may also use computer software to regulate conditions in the environmental chamber.

The instruments described above in accordance with the present invention can screen a library having 2 or more material samples, and preferably, at least 8 samples to ensure adequate screening throughput. Those of skill in the art will appreciate that lower or higher throughput may serve the needs of a particular application of this invention. Thus, 4 or more, 8 or more, 16 or more, 24 or more, or 48 or more electric field generators and/or response sensing devices in parallel are within the scope of this invention.

For methods directed to characterizing a plurality of samples, a property of each of the samples or of one or more components thereof is detected—serially or in a parallel, serial-parallel or hybrid parallel-serial manner—at an average sample throughput of not more than about 10 minutes per sample. As used in connection herewith, the term “average sample throughput” refers to the sample-number normalized total (cumulative) period of time required to detect a property of two or more samples with a characterization system. The total, cumulative time period is delineated from the initiation of the characterization process for the first sample, to the detection of a property of the last sample or of a component thereof, and includes any intervening between-sample pauses in the process. The sample throughput is more preferably not more than about 8 minutes per sample, even more preferably not more than about 4 minutes per sample and still more preferably not more than about 2 minutes per sample. Depending on the quality resolution of the characterizing information required, the average sample throughput can be not more than about 1 minute per sample, and if desired, not more than about 30 seconds per sample, not more than about 20 seconds per sample or not more than about 10 seconds per sample, and in some applications, not more than about 5 seconds per sample and not more than about 1 second per sample. Sample-throughput values of less than 4 minutes, less than 2 minutes, less than 1 minute, less than 30 seconds, less than 20 seconds and less than 10 seconds are demonstrated in the examples. The average sample-throughput preferably ranges from about 10 minutes per sample to about 10 seconds per sample, more preferably from about 8 minutes per sample to about 10 seconds per sample, even more preferably from about 4 minutes per sample to about 10 seconds per sample and, in some applications, most preferably from about 2 minutes per sample to about 10 seconds per sample.

As for screening throughput for parallel embodiments, up to 96 library members may have their mechanical properties measured simultaneously in about 10 minutes or less, preferably about 5 minutes or less and even more preferably in about 1 minute or less. In some parallel embodiments, screening throughput of even about 30 seconds or less may be accomplished for an array of the sizes discussed herein, e.g., up to 96 samples or members in the array.

A sample-throughput of 10 minutes per sample or less is important for a number of reasons. Systems that detect a property of a sample or of a component thereof at the aforementioned sample throughput rates can be employed effectively in a combinatorial research program. From a completely practical point of view, the characterization rates are also roughly commensurate with reasonably-scaled sample library synthesis rates. It is generally desirable that combinatorial screening systems, such as the characterization protocols disclosed herein, operate with roughly the same sample throughput as combinatorial synthesis protocols—to prevent a backlog of uncharacterized polymerization product samples. Hence, because moderate scale polymer-synthesis systems, such as the Discovery Tools™ PPR-48™ (Symyx Technologies, Santa Clara Calif.), can readily prepare libraries with a sample-throughput of about 100 polymer samples per day, a screening throughput of about 10 minutes per sample or faster is desirable. Higher throughput synthesis systems demand higher characterization throughputs. The preferred higher throughput values are also important with respect to process control applications, to provide near-real time control data.

Additionally, as shown in connection with the examples provided herein, the characterization of samples at such throughputs can offer sufficiently rigorous quality of data, to be useful for scientifically meaningful exploration of the material compositional and/or reaction conditions research space.

The present invention may be employed by itself or in combination with other screening protocols for the analysis of liquids or their consitituents. Without limitation, examples of such screening techniques include those addressed in commonly-owned U.S. Pat. Nos. 6,182,499 (McFarland, et al); U.S. Pat. No. 6,175,409 B1 (Nielsen, et al); U.S. Pat. No. 6,157,449 (Hajduk, et al); U.S. Pat. No. 6,151,123 (Nielsen); U.S. Pat. No. 6,034,775 (McFarland, et al); U.S. Pat. No. 5,959,297 (Weinberg, et al), U.S. Pat. No. 5,776,359 (Schultz, et al.), commonly owned and co-pending U.S. patent application Ser. No. 09/580,024 titled “Instrument for High Throughput Measurement of Material Physical Properties and Method of Using Same,” filed on May 26, 2000, all of which are hereby expressly incorporated by reference herein.

Screening techniques may also include (without limitation) optical screening, infrared screening, electrochemical screening, flow characterization (e.g., gas, liquid or gel-phase chromatography), spectrometry, crystallography (e.g. X-ray diffraction), or the like.

It will be appreciated from the above that many alternative embodiments exist for high throughput mechanical property screening within the scope of the present invention. Accordingly, the instruments and methods discussed above are to be considered exemplary and nonlimiting as to the scope of the invention.

What is claimed is:

1. A method for screening at least four fluid samples for concentration, comprising:
(a) providing an electric field generator connected to a robot arm;
(b) providing at least four fluid samples;
(c) generating an electric field with the electric field generator;
(d) exposing a sample of the at least four samples to the electric field;
(e) monitoring a response of the sample of the at least four samples to the electric field for at least two locations in the sample of the at least four samples; and
(f) repeating steps (c) through (e) for at least three additional samples.

2. The method of claim 1 further comprising correlating the response monitored in step (e) with a concentration for each sample in the at least four samples.

3. The method of claim 2, wherein the response is monitored over a period of time and concentration is determined as a function of time.

4. The method of claim 2, wherein the response is monitored over a range of depths and concentration is determined as a function of depth.

5. The method of claim 1, wherein the repeating steps are performed simultaneously using a plurality of electric field generators.

6. The method of claim 1 wherein at least one of the repeating steps is performed serially.

7. The method of claim 1 wherein the electrical field generator includes opposing electrodes spaced about a tube through which the sample of the at least four sample is passed.

8. The method of claim 1, wherein the at least four samples are emulsion candidates.

9. A method for screening at least four fluid samples for concentration, comprising:
(a) providing an electric field generator connected to a robot arm being controllably translatable in at least one direction, the electric field generator having at least two spaced apart conductors mounted on a capillary having a tip;
(b) providing at least four fluid samples in wells of a common substrate, each of the at least four fluid samples having more than one phase;
(c) translating the robot arm to submerge the tip of the capillary in a sample of the at least four samples;
(d) generating an electric field with the electric field generator by inducing an electric potential between the conductors;
(e) aspirating the sample of the at least four samples into the tube for exposing the sample of the at least four samples to the electric field;
(f) monitoring a capacitance of the sample of the at least four samples in response to the electric field in at least two locations in the sample of the at least four samples;
(g) relating the capacitance of the sample of the at least four samples to a concentration of at least one of the phases of the sample of the at least four samples; and
(h) repeating steps (c) through (f) for at least three additional samples.

10. The method of claim 9 further comprising transferring the at least four fluid samples into the wells of the substrate with an automated dispenser.

11. The method of claim 9 further comprising graphically displaying the concentration of the at least four samples.

12. The method of claim 9 wherein the conductors are spaced away from the tip such that the conductors are not submerged into the at least four samples.

13. The method of claim 9 further comprising translating the tip vertically as the sample of the at least four sample is aspirated into the tube.

14. The method of claim 9 wherein the capacitance is monitored with electrical circuitry.

15. The method of claim 14 wherein the electrical circuitry is part of a network analyzer.

16. The method of claim 9 wherein the repeating steps are performed simultaneously using a plurality of electric field generators.

17. The method of claim 9 wherein at least one of the repeating steps is performed serially.

18. The method of claim 9 further comprising comparing the concentration of each of the at least four samples.

19. The method of claim 9 wherein the at least four samples are each two-phase emulsion candidates.

20. The method of claim 9 further comprising cleaning the capillary tube between aspiration of each of the samples of the at least four samples.

21. The method of claim 9 further comprising replacing the capillary tube between aspiration of each of the samples of the at least four samples.

22. An apparatus for screening concentration of at least four fluid samples, comprising:
at least one electric field generator for providing at least one electric field;
at least four wells located proximate one another for supporting at least four samples;
at least one automated system connected to the at least one electric field generator for exposing the at least four samples to the at least one electric field; and
electrical circuitry electrically connected to the at least one electrical field generator for monitoring a response of each of the at least four samples to the electric field wherein the concentration of the at least four fluid samples is determinable from the response.

23. The apparatus of claim 22, the automated system includes a robot arm capable of moving the at least one electric field generator from samples to sample within the at least four samples.

24. The apparatus of claim 23, wherein the at least one electric field generator includes a tube connected to a first conductor and a second conductor.

25. The apparatus of claim 24, wherein the robot arm is configured for submerging an end of the tube into each of the at least four samples at a substantially constant rate such that the concentration of the at least four samples may be determined relative to the depth within the at least four samples.

26. The apparatus of claim 25, further comprising a vacuum source for aspirating each of the at least four samples into the tube as the end of the tube is submerged into the at least four samples.

27. The apparatus of claim 22, wherein the electrical circuitry monitors the response of each of the samples of the at least four samples simultaneously.

28. The apparatus of claim 27, wherein the electrical circuitry includes a plurality of units, the at least one electric field generator includes a plurality of electric field generators, each of the plurality of electric field generators connected to a different one of the plurality of units.

29. The apparatus of claim 22, wherein the electrical circuitry is included in a network analyzer.

30. An apparatus for screening a library of at least four fluid samples, comprising:
a three axis robot;
a substrate including at least four wells for supporting the at least four fluid samples;
a capillary tube connected to the three axis robot such that the robot is capable of moving the tube from sample to sample within the library of at least four fluid samples, the tube having an opening extending through the tube and an outer surface;
a first conductor attached to the outer surface of the tube and a second conductor attached to the outer surface of the tube, the opening of the tube being at least partially located between the first conductor and second conductor;
an energy source electrically connected to the first conductor and the second conductor for inducing an electric field between the first conductor and the second conductor;
electrical circuitry electrically connected to the first conductor and the second conductor, the electrical circuitry configured for monitoring a dielectric response of materials that are exposed to the electric field between the first conductor and the second conductor;
a vacuum supply in fluid communication with the opening of the tube for aspirating the at least four samples into the opening thereby exposing each sample of the at least four samples to the electric field.

31. The apparatus of claim 30, wherein the robot arm is configured for submerging an end of the tube into each of the at least four samples at a substantially constant rate such that the concentration of the at least four samples may be determined relative to the depth within the at least four samples.

32. The apparatus of claim 30, wherein the electrical circuitry is included in a network analyzer.

33. The apparatus of claim 30, further comprising another robot arm connected to another first conductor and another second conductor for generating another electric field.

34. The apparatus of claim 30, further comprising another capillary tube connected to another first conductor, another second conductor and the robot arm for generating another electric field.
